(19) United States
(12) Patent Application Publication
(10) Pub. No.: US 2022/0386781 A1
(43) Pub. Date: Dec. 8, 2022

(54) Portable Upholstered Folding Chair With Battery Powered Comfort Controls

(71) Applicant: Jordan Hergott, RANCHO DOMINGUEZ, CA (US)

(72) Inventor: Jordan Hergott, RANCHO DOMINGUEZ, CA (US)

(21) Appl. No.: 17/777,036

(22) PCT Filed: Nov. 16, 2020
(86) PCT No.: PCT/US20/60744

§ 371 Date: May 15, 2022

Related U.S. Application Data
(60) Provisional application No. 62/936,590, filed on Nov. 17, 2019.

(51) Int. Cl. A47C 7/72; A47C 4/00; A61H 7/00; H05B 1/02; G05D 23/24

(52) U.S. Cl. CPC A47C 7/72; A47C 4/00; A61H 7/004; H05B 1/0272; G05D 23/24; A47C 4/24

(57) ABSTRACT

An upholstered portable folding chair with battery powered comfort controls having a portable folding chair frame, a back-rest portion having temperature control and massage units, a seat portion having temperature control and massage units, a control unit affixed to the frame to control the temperature adjustment units and the massage units, and a battery providing at least four (4) hours of continual operation of the chair.

### CROSS-REFERENCE TO RELATED APPLICATIONS

This application claims the benefit under 35 U.S.C. § 119(e) of U.S. Provisional Patent Application Ser. No. 61/796,505, filed on Nov. 11, 2019, and PCT Application No. PCT/US20/60744 filed Nov. 16, 2020, the contents of which are incorporated herein by reference in their entirety.

### FIELD OF THE INVENTION

The present invention is in the technical field of upholstered portable folding chairs and more particularly to an upholstered portable folding chair with battery powered comfort controls within the back-rest portion and seat portion.

### BACKGROUND

Currently available upholstered portable folding chairs 100, as shown in FIG. 1 are more comfortable for a user to sit on for an extended period of time. However, for certain events, such as, for example, a sporting event the upholstered chairs comfort fades as the event progresses. Heating, cooling and massage would extend the comfort time spent in the chair and would, in fact, assist athletes or other users in maintaining a readiness for the event, prevent injuries, an assist with recovery from fatigue or minor muscle issues.

Although there are a variety of heating and massaging chairs available on the market, currently, there are no therapeutic portable heated/massage chairs available. The bulk and heft of currently available heated chairs make it impossible for them to be moved around in quantity for events or for traveling individuals that might need the chair for therapeutic reasons. The immobility of the current art locks a user into using the heated massage chair only where they are located, causing the user to travel to the unit rather than the ease of taking the unit with the use.

Also, disadvantageously, the currently available bulky comfort chairs require a cord and a power outlet to use the device. This further makes them unusable at temporary setups, or where the venue changes configurations.

Multiple individual devices also do not fit the need, as each device would need to be taken on every trip, set up, and it would not be set for the users needs at the beginning. Multiple adjustments would need to be made in order to provide the user with a comfort level that they would find acceptable. This constant fumbling with controls to adjust the individual devices to an acceptable comfort level would also distract the user from the event.

Therefore, there is a need for an upholstered portable folding chair with battery powered comfort controls within the back-rest portion and seat portion, wherein the comfort controls comprise one or more than one temperature adjustment unit and one or more than one massage unit or both one or more than one temperature adjustment unit and one or more than one massage unit integrated within the back-rest portion and seat portion, overcoming the limitations of the prior art.

### BRIEF DESCRIPTION OF THE DRAWINGS

These and other features, aspects and advantages of the present invention will become better understood with regard to the following description, appended claims, and accompanying figures where:

FIG. 1 is a prior art diagram of a folding chair;

FIG. 2 is a diagram of an upholstered portable folding chair with battery powered comfort controls within the back-rest portion and seat portion according to one embodiment;

FIG. 3 is a diagram of an upholstered portable folding chair with battery powered comfort controls within the back-rest portion and seat portion, wherein the comfort controls are operably connected to resistance temperature detectors (RTD) according to one embodiment;

FIG. 4 is a diagram of an upholstered portable folding chair with battery powered comfort controls showing one or more than one massager unit integrated within the back-rest portion, according to one embodiment;

FIG. 5 is a diagram of an upholstered portable folding chair with battery powered comfort controls showing one or more than one temperature adjustment unit integrated within the back-rest portion, according to one embodiment;

FIG. 6 is a diagram of an upholstered portable folding chair with battery powered comfort controls showing one or more than one temperature adjustment unit integrated within the seat portion, according to one embodiment;

FIG. 7 is a diagram of a battery pack/charger/controller unit attached securely to the seat portion of an upholstered portable folding chair with battery powered comfort controls;

FIG. 8 and FIG. 9 are top and side view diagrams of wiring connections from battery pack/charger/controller unit to the back-rest portion and the seat portion, according to one embodiment;

FIG. 10 is a close up diagram of a battery pack/charger/controller unit, according to one embodiment; and

FIG. 11 is an internal exploded view of the battery pack/charger/controller unit of FIG. 9.

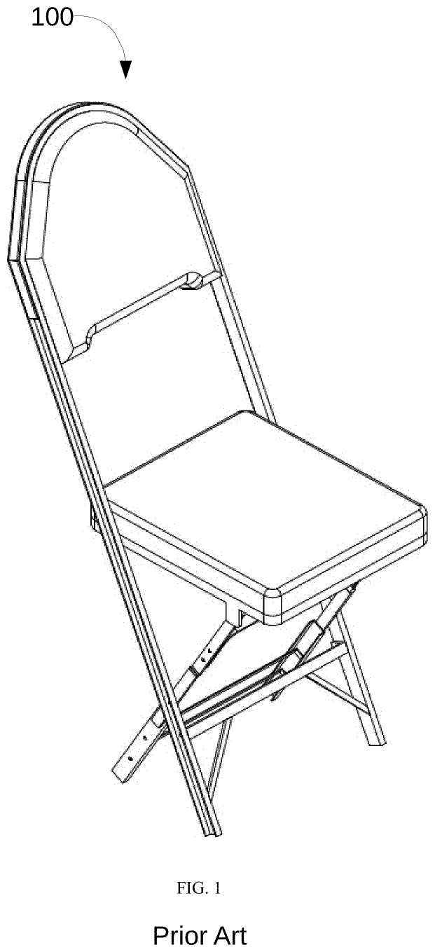

### SUMMARY

The present invention overcomes the limitations of the prior art by providing an upholstered portable folding chair with battery powered comfort controls within the back-rest portion and seat portion. The chair comprises a portable folding chair frame, a back-rest portion operably connected to the portable folding chair frame having one or more than one temperature adjustment unit and/or one or more than one massage unit, a seat portion operably connected to the portable folding chair frame having one or more than one temperature adjustment unit and/or one or more than one massage unit, one or more than one temperature adjustment unit affixed to the portable folding chair frame for controlling the one or more than one temperature adjustment unit and/or the one or more than one massage unit, and a battery unit affixed to the portable folding chair frame operably connect to the one or more than one control unit. In one embodiment, both the one or more than one temperature adjustment unit and one or more than one massage unit are integrated within the back-rest portion and seat portion. The temperature adjustment unit is selected from the group consisting of resistance wire, ceramic and semiconductor, thick film, polymer PTC temperature adjustment unit, composite temperature adjustment unit, and combination temperature adjustment unit. In another embodiment, the one or more than one temperature adjustment unit and/or the one or more than one massage unit are fully integrated and non-removable from the chair. In another embodiment, the one or more than one temperature adjustment unit, the one or more than one massage unit are separate removable units that are capable of being quickly integrated into the chair. The operation controls are wired, wireless or both wired and wireless.

The portable upholstered folding chair with battery powered comfort controls further comprises a back lumbar element and/or a portable removable booster seat cushion having one or more than one temperature adjustment unit and one or more than one massage unit connectable to the control unit.

The operation controls comprise an electronic control module that regulates the temperature settings, a one hour timer shut-off, system diagnostics to assure correct operation, illuminated manual control switches for setting the comfort controls, an electrical harness for connecting the controller to the back-rest portion, the seat portion, the lower back lumbar support and the portable removable booster seat cushion, a protective cover to protect the electrical harness and connectors, a battery pack, a battery charger, and an enclosure for protecting the battery pack and electronic control module. In one embodiment, the operation controls are manual only and affixed to the portable folding chair frame. In another embodiment, the operations controls are wired, wireless, or both wired and wireless providing flexibility for controlling the temperature and massage.

The battery unit has sufficient power to operate the chair for providing at least four hours of continuous operation and is selected from the group consisting of lead acid, nickel chromium oxide (NmCD), lithium ion (Li), lithium iron phospate4 (LiFEPo4), and absorbent glass mat.

The portable upholstered folding chair with battery powered comfort controls of claim 1, wherein the operation controls for controlling the one or more than one temperature adjustment unit and the one or more than one massage unit affixed to the portable folding chair frame are manual controls.

The temperature adjustment units are automatically controlled by resistance temperature detectors operably connected to the operation controls.

In yet another embodiment, the one or more than one massage unit also comprises controllable temperature adjustable elements, thereby reducing the number of units needed to be added to the chair.

### DETAILED DESCRIPTION OF THE INVENTION

The present invention overcomes the limitations of the prior art by providing an upholstered portable folding chair with battery powered comfort controls within the back-rest portion and seat portion, wherein the comfort controls comprise one or more than one temperature adjustment unit and one or more than one massage unit or both one or more than one temperature adjustment unit and one or more than one massage unit integrated within the back-rest portion and seat portion.

What is described is a high-end upholstered portable metal folding chair includes two pairs of front legs with filled in “K” braces and a welded metal panel between the rear legs pivotally connected with each other so, as to be operable to fold or unfold the folding chair. When unfolded, each of the front legs and the rear legs form an angle relative to a horizontal plane. The back-rest frame is disposed between the front leg frame and the back-rest. The back-rest is placed on the back-rest frame, which relieve stress. Thus, a ridge of the back-rest does not deform, and the back-rest is securely fixed, where the back-rest plate is welded or back-rest wood insert w/wood screws are used to affix the back-rest plate, on a high-end upholstered metal folding chair. The seat frame is disposed between the front leg frame and below the back-rest. The seat frame is attached with hinges between the right and left front legs. Contained within the upholstered back-rest portion and upholstered seat portion are temperature adjustment and/or massage units.

A primary objective of the present invention is to provide a high-end upholstered portable folding chair that has a separate temperature adjustment and/or massage unit integrated within the chair's cushioned upholstered back-rest portion and seat portion for immediate muscle relaxation, pain relief, physical and therapeutic benefits for the game-day active player athletes and health care patients.

Another objective of the present invention is to provide a high-end upholstered portable folding chair that is extremely strong and durable while safely protecting the integrated temperature adjustment and/or massage units for immediate use, and ease of setup, tear down and storage.

Other contemplated embodiments include a cover that can slide over the back of an existing chair and seat that would make an ordinary seat comprise heat and massage without altering the seat/chair. Also a booster seat would would have the heat and massage capabilities. This embodiment would allow a shorter seat to have an increase in height and capabilities while remaining portable and therapeutic.

Other aspects of the invention include a vinyl seat and/or back separate removable cover overlay for attachment on portable chair. These sewn covers are designed to fit over the chair's cushioned back and/or cushioned seat for easy attachment and removable as necessary. Additionally, inside the sewn cover are temperature adjustment and massage units for immediate health, physical and therapeutic benefits. This temperature adjustment unitis modified slightly in size and structure to fit inside the removable sewn cover. It is easily adapted to fit existing portable chairs, removable and available for immediate health benefit use.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, certain terminology is used to describe certain features of one or more embodiments of the invention.

The term “Resistance Temperature Detector” (RTD) refers to precision temperature sensors made from high-purity conducting metals such as platinum, copper or nickel wound into a coil and whose electrical resistance changes as change of temperature, similar to that of a thermistor with an accurate temperature reading from −182.96° C. to 630.74° C.

The term “temperature adjustment unit” refers to any controllable device that can produce heat, cold or both heat and cold.

Various embodiments provide a portable chair with battery powered comfort controls. One embodiment of the present invention provides a portable chair with battery powered comfort controls. In another embodiment, there is provided a method for using the system. The system and method will now be disclosed in detail.

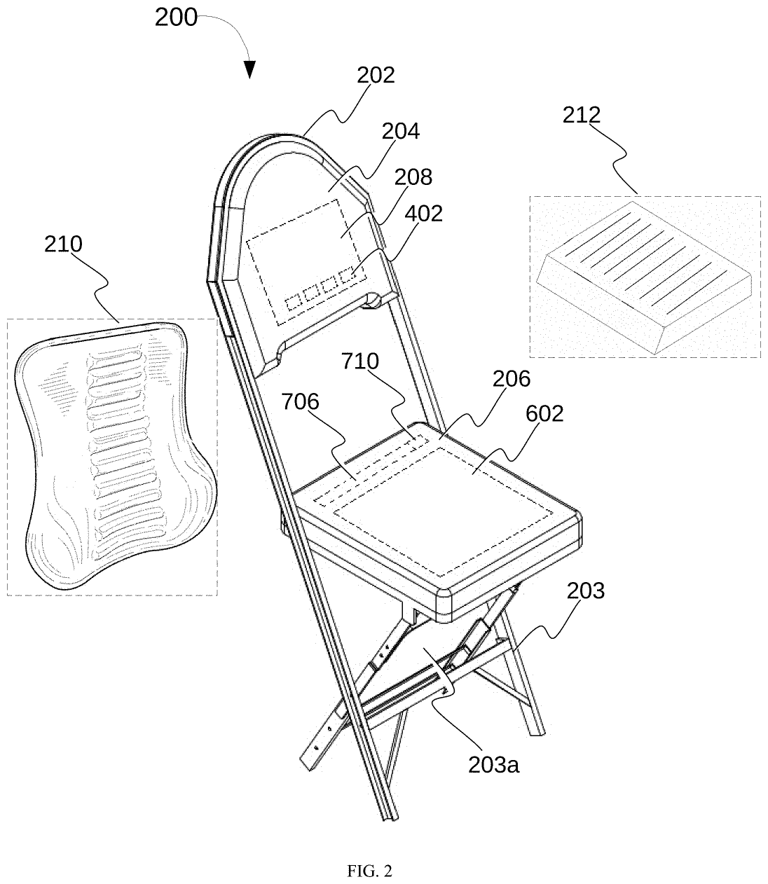

FIG. 2 is a diagram of an upholstered portable folding chair with battery powered comfort controls 200 within the back-rest portion 204 and seat portion 206 according to one embodiment. As can be seen, the upholstered portable folding chair with battery powered comfort controls 200 within the back-rest portion 204 and seat portion 206 200 comprises: a portable folding chair frame 202, a back-rest portion 204 operably connected to the portable folding chair frame 202, a seat portion 206 operably connected to the portable folding chair frame, one or more than one control unit 706 operably connected to the portable folding chair frame, one or more than one massage unit 402 affixed to the back-rest portion 204 and the seat portion 206, one or more than one temperature adjustment unit 208, 504 and 602 affixed to the back-rest portion 204 and the seat portion, operation controller 710 for controlling the one or more than one controls 708 and the one or more than one massage unit 402 affixed to the portable folding chair frame 202, and an enclosure 706 affixed to the portable folding chair frame 202.

Optionally, there is a lower back lumbar support 210 that comprises one or more than one heater/massager element that can be operably connected to the upholstered portable folding chair with battery powered comfort controls within the back-rest portion 204 and seat portion 206.

Also optionally, there is provided a portable removable booster seat cushion 212 is ideal for increasing the seat heights of standard portable chairs when placed on top of the portable chair seat portion 206 to accommodate/benefit taller users with increased knee and leg comfort during events while seated. The portable removable booster seat cushion 212 can also be outfitted with additional temperature adjustment and massage units that can be operably attached to the portable folding chair 200. It is contemplated that the portable removable booster seat portion 212 comprises a totally integrated temperature adjustment and/or massage units. The cover of the portable removable booster seat cushion 212 is made with any suitable long wear material and comprises a zipper, Velcro(r) or sewn enclosure that has a high-density foam or molded foam seat cushion approximately two inches to ten inches thick for immediate health, physical and therapeutic benefits.

In order to achieve the objectives mentioned above, a high-end upholstered portable folding chair 200, according to the present invention includes two pairs of front legs with filled in metal “K” braces 203 and a welded metal panel 203a between the rear legs of the “K” braces 203 and pivotally connect with each other. Thus, the front and rear legs are operable to unfold or fold relative to each other. When unfolded, the front legs and the rear legs form an angle relative to a horizontal plane.

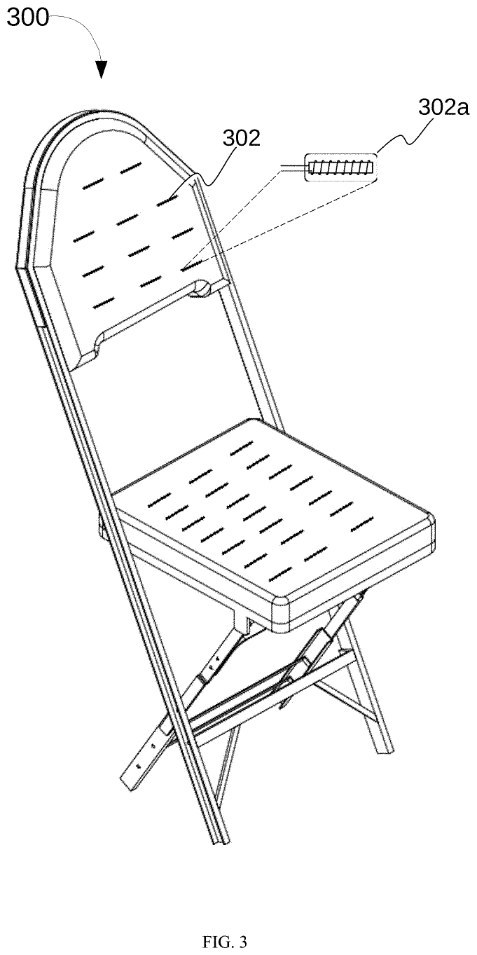

FIG. 3 is a diagram of an upholstered portable folding chair with battery powered comfort controls within the back-rest portion 204 and seat portion 206, wherein the comfort controls are operably connected to one or more than one resistance temperature detectors 300 (RTD) according to one embodiment. In this embodiment, the one or more than one one temperature adjustment unit 208, 504 and 602 is a controlled by one or more than one fully integrated RTD unit. The operation controller 710 receives temperature readings from the one or more than one one temperature adjustment unit 208, 504 and 602 via the one or more than one RTD 302, that is electronically attached to the one or more than one temperature adjustment unit 208, 504 and 602. The operation controller 710 is then able to adjust the amount of power that is sent to the one or more than one one temperature adjustment unit 208, 504 and 602, thereby regulating the temperature for maximum effectiveness for the user.

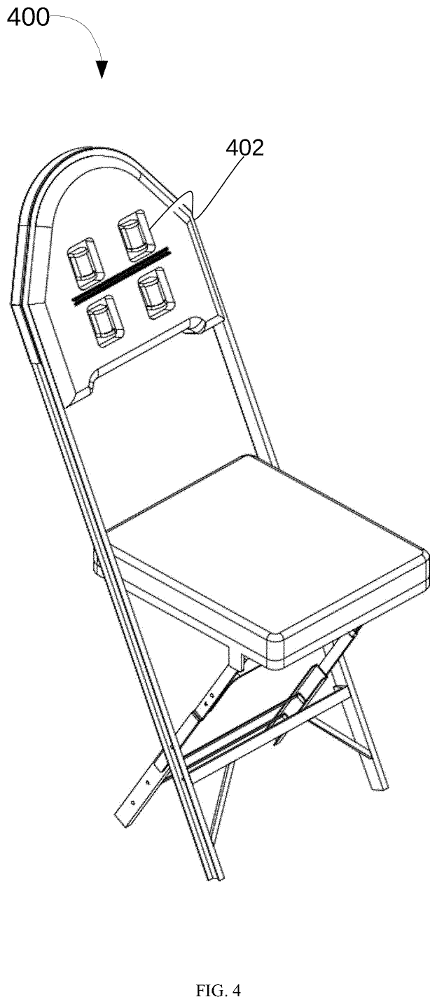

Referring now to FIG. 4, there is shown a diagram of an upholstered portable folding chair with battery powered comfort controls showing one or more than one massager unit 400 integrated within the back-rest portion 204, according to one embodiment. As can be seen, the one or more than one massage unit 402 is located in the back-rest portion 204. Although not shown, it the one or more than one massage unit 402 can also be located in the seat portion 206 of the chair 200. The one or more than one massage unit 402 is activated and operated by the controller 710. The one or more than one massage unit 402 can be adjusted by the user using manual controls located on the chair 200, remotely by using a smart device wirelessly connected to the controller 710 or both manually and remotely. Additionally, a third party can control the one or more than one massage unit 402 remotely with a hand control unit (not shown), or wirelessly, thereby enabling control of the chair 200 by a doctor, physical therapist, or other qualified personnel. Optionally, the one or more than one massage unit 402 can also comprise controllable temperature adjustable elements, thereby reducing the number of units needed to be added to the chair 200.

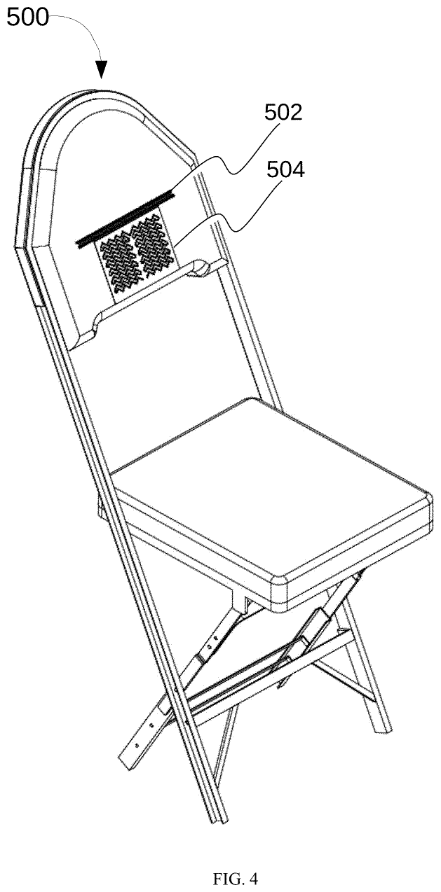

Referring now to FIG. 5 and FIG. 6, there is shown diagrams of an upholstered portable folding chair with battery powered comfort controls showing one or more than one temperature adjustment unit 504 and 602 integrated within the back-rest portion 204, and the seat portion 206, according to one embodiment. Additionally, a temperature sensor 502 can be used to regulate the one or more than one temperature adjustment unit 504 and 602. Each of the one or more than one temperature adjustment unit 504 and 602 are selected from the group consisting of resistance wire, ceramic, semiconductor, thick film, polymer PTC, ceramic PTC, ribbon, coil, straight, etched foil, composite heating element, and a combination heating element. As can be appreciated, the temperature adjustment unit 500 and 600 on the back-rest portion 204 can be different from the one or more than one temperature adjustment unit 504 and 602 used in the seat portion 206 to maximize durability and usefulness of the one or more than one heating element 504 and 602.

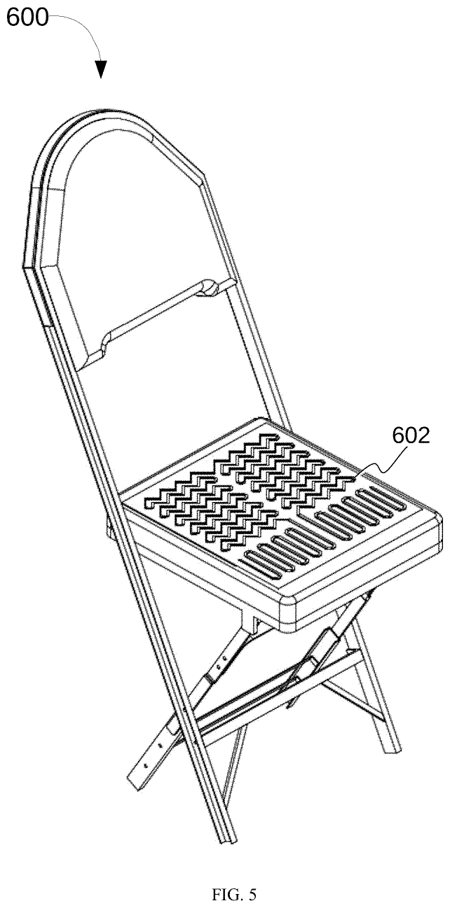

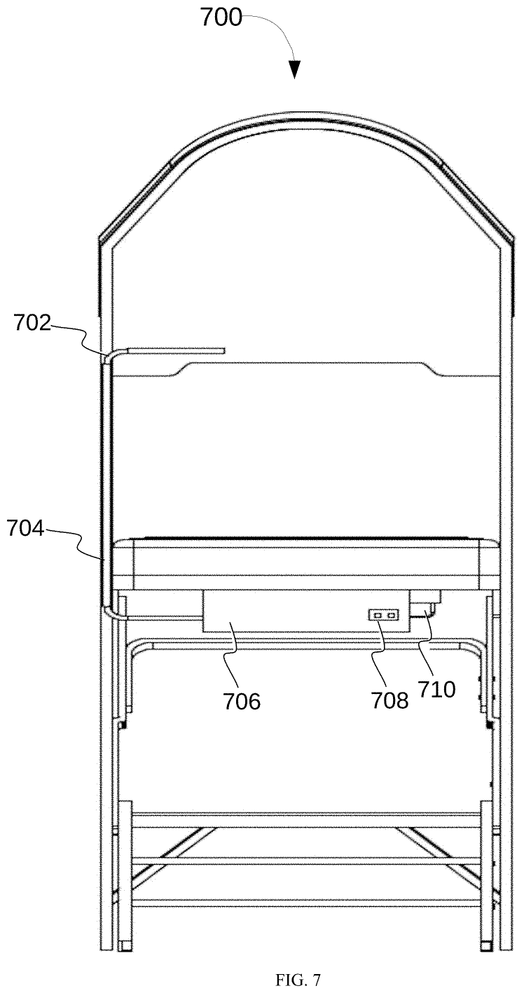

Referring now to FIG. 7, there is shown is a diagram of a battery pack/charger/controller unit 700 attached securely to the chair frame 202 of an upholstered portable folding chair with battery powered comfort controls 200. Upper control connection 702 is affixed to the back-rest portion 204 of the chair 200. A covering 704 is affixed to the chair frame 202 to protect the upper control connection 702 from damage while the chair 200 is being moved or stored. An enclosure 706 holds the battery pack and electronic control module 710 and is affixed to the chair frame 202.

Manual controls 708 are affixed to the enclosure 706. The manual controls 708 comprise a high, off, and low, and various other option using one or more than one illuminated switch or control dial electrically connected with switch harness 800 to control the temperature adjustment and massage units 504 and 602. Specifically, the illuminated switch/control module w/switch harness is mounted securely to the right front leg metal “K” brace support. Additionally, the manual controls 708 and the enclosure can connect to the optional lower back lumbar support 210 and the portable removable booster seat cushion 212.

An electronic control module 710 regulates the temperature settings. For a manual only chair 200, the electronic control module 710 comprises a one hour timer shut-off, to prevent overheating or electrical fire. The same control module 710 also comprises diagnostics of the system to assure it is operating correctly. For remote operation, an application is loaded onto a smart device and comprises instructions operable on one or more than one processor to control the temperature adjustment and massage units.

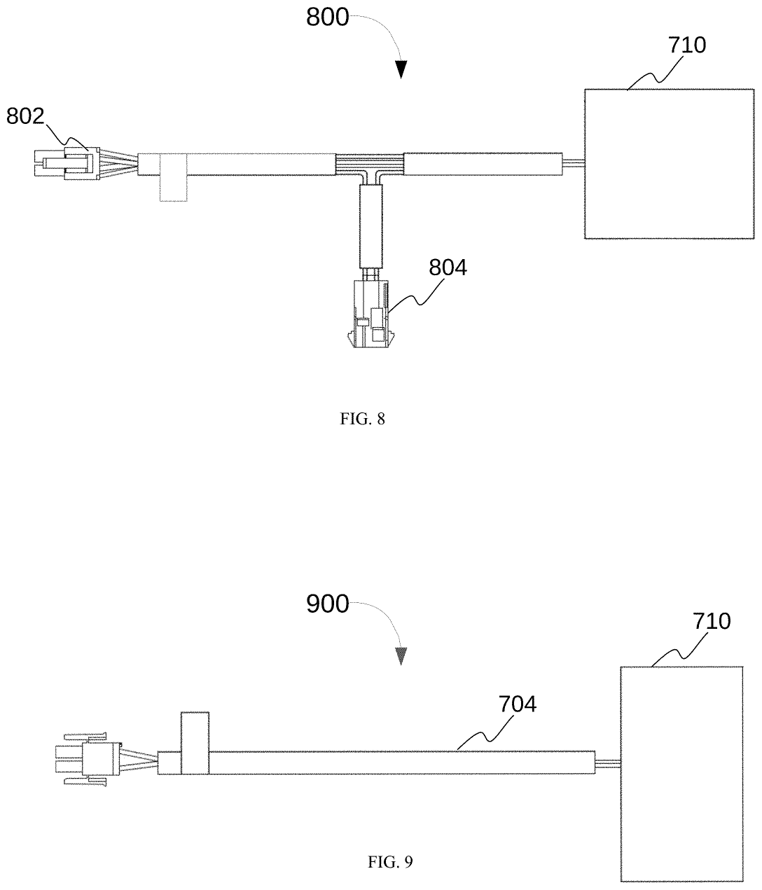

Referring now to FIG. 8 and FIG. 9, there is shown top and side view diagrams of wiring connector 800 and 900 from the battery pack/charger/controller unit 710 to the back-rest portion 204 and the seat portion 206, according to one embodiment. The wiring connector 800 and 900 comprises one or more than one electrical quick connect 802 and 804 to easily attach the battery pack/charger/controller unit 710 to the back-rest portion 204 and the seat portion 206. Optionally, there are additional wire quick connects (not shown) to connect the battery pack/charger/controller unit 710 to the lower back lumbar support 210 and the portable removable booster seat cushion 212. Moreover, there is a protective cover 704 that protects the wiring when the chair 200 is stored or moved. All wiring is routed to the battery pack/charger/controller 710 that is securely affixed to the inside metal plate between the two rear legs, keeping the wiring and the batteries out of sight and safe from inadvertent strikes or damage.

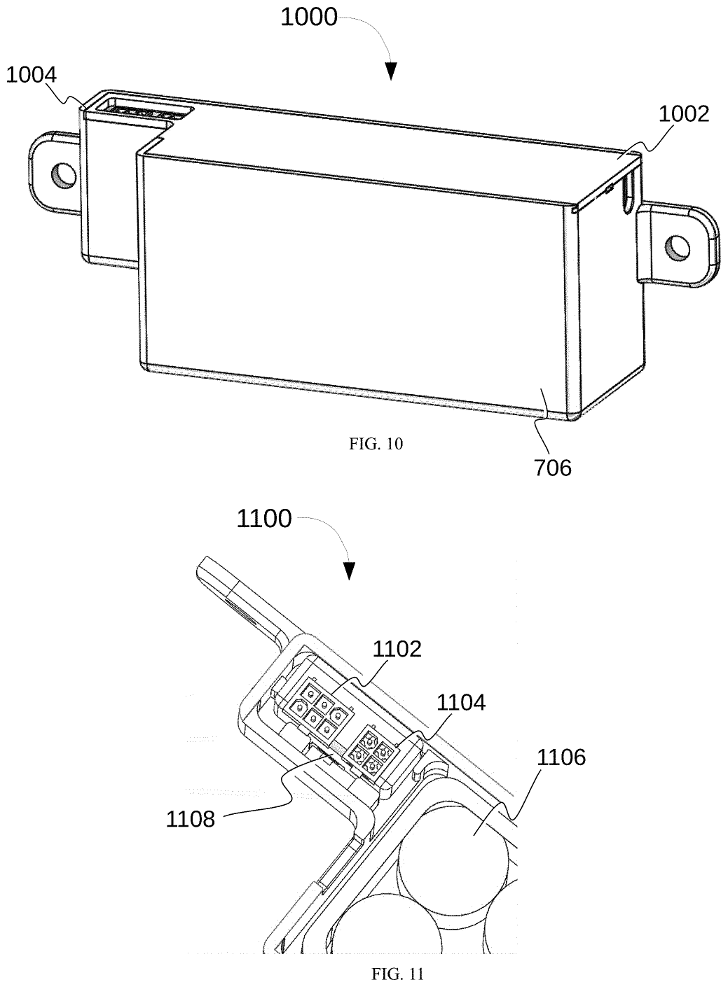

Referring now to FIG. 10, there is shown a close up diagram 1000 of a battery pack/charger/controller unit, according to one embodiment. The enclosure 706 comprises a lid 1002 and a wiring access port 1004. The lid 1002 is operably fixed to the enclosure 706 for easy access to the enclosure's 706 internals. The wiring access port 1004 allow for the one or more than one electrical quick connect 802 and 804 to be quickly and easily attached to the battery/charger/controller 710.

Referring now to FIG. 11, there is shown an internal exploded view 1100 of the battery pack/charger/controller unit of FIG. 10. As shown in this embodiment, one or more than one female wiring connectors 1102 and 1104 are keyed to only allow the correct one or more than one electrical quick connect 802 and 804 to be attached. This prevents faulty wiring, power and control signals being sent to the chair 200.

The enclosure 706 that holds the battery pack 1106 and also comprises an electronic control module 1108. In one embodiment, the electronic control module 1108 comprises one or more than one processor that is encoded with instructions operable on the processor to control the one or more than one temperature adjustment unit 208, 504 and 602 and the one or more than one massage unit 402. In a manually operated chair 200, the electronic control module 1108 also regulates the temperature setting and comprises a one hour timer shut-off for safety and can run diagnostics of the chair 200 to assure it is operating correctly. The diagnostics can indicate safe use by either sound or a light indicator. If the diagnostics fail, the chair will not operate to protect the user from potential harm.

A battery pack 1006 is also shown. In this embodiment, the battery pack 1006 can be selected from the group consisting of lead acid, nickel chromium oxide (NmCD), lithium ion (Li), lithium iron phospate4 (LiFEPo4), and absorbent glass mat. Preferably, the battery pack 1006 is LiFEPo4 due to the large number of battery cycles and the resistance to explosive chemistry. The battery pack 1106 is rated at a minimum of 10 amp hour, 12 volts, providing four (4) hours of continuous operation of the chair 200.

Additionally, the one or more than one female wiring connectors 1102 and 1104 comprise a battery charger port for recharging the battery pack 1106 between uses.

What has been described is a new and improved system for an upholstered portable folding chair with battery powered comfort controls within the back-rest portion and seat portion, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. An upholstered portable folding chair with battery powered comfort controls comprising:
a. a portable folding chair frame;
b. a back-rest portion operably connected to the portable folding chair frame having one or more than one temperature adjustment unit;
c. a back-rest portion operably connected to the portable folding chair frame having one or more than one massage unit;
d. a seat portion operably connected to the portable folding chair frame having one or more than one temperature adjustment unit;
e. a seat portion operably connected to the portable folding chair frame having one or more than one massage unit;
f. one or more than one control unit affixed to the portable folding chair frame for controlling the one or more than one temperature adjustment unit and the one or more than one massage unit; and
g. a battery unit affixed to the portable folding chair frame operably connect to the one or more than one control unit.

2. The portable upholstered folding chair with battery powered comfort controls of claim 1, where both one or more than one temperature adjustment unit and one or more than one massage unit are integrated within the back-rest portion and seat portion.

3. The portable upholstered folding chair with battery powered comfort controls of claim 1, wherein the one or more than one temperature adjustment unit is selected from the group consisting of resistance wire, ceramic and semiconductor, thick film, polymer PTC temperature adjustment unit, composite temperature adjustment unit, and combination temperature adjustment unit.

4. The portable upholstered folding chair with battery powered comfort controls of claim 1, wherein the one or more than one temperature adjustment unit, the one or more than one massage unit are fully integrated and non-removable from the chair.

5. The portable upholstered folding chair with battery powered comfort controls of claim 1, wherein the one or more than one temperature adjustment unit, the one or more than one massage unit are separate removable units that are capable of being quickly integrated into the chair.

6. The portable upholstered folding chair with battery powered comfort controls of claim 1, wherein the operation controls are wired, wireless or both wired and wireless.

7. The portable upholstered folding chair with battery powered comfort controls of claim 1 further comprising a back lumbar element having one or more than one temperature adjustment unit and one or more than one massage unit connectable to the control unit.

8. The portable upholstered folding chair with battery powered comfort controls of claim 1 further comprising a portable removable booster seat cushion having one or more than one temperature adjustment unit and one or more than one massage unit connectable to the control unit.

9. The portable upholstered folding chair with battery powered comfort controls of claim 1, wherein the operation controls comprise:
a. an electronic control module that regulates the temperature setting of the one or more than one temperature adjustment unit;
b. a one hour timer shut-off;
c. system diagnostics to assure correct operation;
d. illuminated manual control switches for setting the comfort controls;
e. an electrical harness for connecting the controller to the back-rest portion, the seat portion, the lower back lumbar support and the portable removable booster seat cushion;
c. a protective cover to protect the electrical harness and connectors;
d. a battery pack;
e. a battery charger; and
f. an enclosure for protecting the battery pack and electronic control module.

10. The portable upholstered folding chair with battery powered comfort controls of claim 9, wherein the battery unit comprises sufficient power to operate the chair for four hours.

11. The portable upholstered folding chair with battery powered comfort controls of claim 9, where the battery unit is selected from the group consisting of lead acid, nickel chromium oxide (NmCD), lithium ion (Li), lithium iron phospate4 (LiFEPo4), and absorbent glass mat providing at least four hours of continuous operation.

12. The portable upholstered folding chair with battery powered comfort controls of claim 1, wherein the operation controls for controlling the one or more than one temperature adjustment unit and the one or more than one massage unit affixed to the portable folding chair frame are manual controls.

13. The portable upholstered folding chair with battery powered comfort controls of claim 1, wherein the operation controls for controlling the one or more than one temperature adjustment unit and the one or more than one massage unit affixed to the portable folding chair frame are wirelessly remote controls.

13, wherein the temperature adjustment units are automatically controlled by resistance temperature detectors operably connected to the operation controls.

15. The portable upholstered folding chair with battery powered comfort controls of claim 1, wherein the one or more than one massage unit also comprise controllable temperature adjustable elements, thereby reducing the number of units needed to be added to the chair.
